(19) United States
(12) Patent Application Publication
(10) Pub. No.: US 2021/0375511 A1
(43) Pub. Date: Dec. 2, 2021

(54) YCO5-BASED COMPOUNDS DOPED WITH FE AND NI FOR HIGH-PERFORMANCE PERMANENT MAGNETS

(71) Applicant: Lawrence Livermore National Security, LLC, Livermore, CA (US)

(72) Inventors: Alexander Landa, Livermore, CA (US); Per Soderlind, Oakland, CA (US); Emily Moore, Livermore, CA (US); Aurelien Perron, Pleasanton, CA (US)

(21) Appl. No.: 17/398,905

(22) Filed: Aug. 10, 2021

Related U.S. Application Data
(63) Continuation-in-part of application No. 16/478,807, filed on Jul. 17, 2019.
(60) Provisional application No. 62/447,373, filed on Jan. 17, 2017.

(51) Int. Cl. H01F 1/047; C22C 30/00

(52) U.S. Cl. CPC H01F 1/047; C22C 2202/02; C22C 30/00

(57) ABSTRACT

In accordance with one aspect of the presently disclosed inventive concepts, a magnet includes a material having a chemical formula: YFe₃(Ni₁₋ₓCoₓ)₂, where x is greater than 0 and x is less than 1.

### RELATED APPLICATIONS

This application is a Continuation in Part of U.S. Non-Provisional patent application Ser. No. 16/478,807 filed Jul. 17, 2019, which is a National Stage Entry of PCT/US2018/014040 filed Jan. 17, 2018, that claims priority to U.S. Provisional Application No. 62/447,373 filed Jan. 17, 2017, all of which are herein incorporated by reference.

This invention was made with Government support under Contract No. DE-AC52-07NA27344 awarded by the United States Department of Energy. The Government has certain rights in the invention.

### FIELD OF THE INVENTION

The present invention relates permanent magnets, and more particularly, this invention relates to YCo₅-based magnets.

### BACKGROUND

Among the great challenges of materials science is discovering a material that satisfies conflicting requirements and also possesses specific properties for a particular application. There is a need for strong permanent magnets to withstand higher temperatures, for example Curie temperatures ranging from 800 K to 1200 K, which the widely used neodymium-based magnets (Nd₂Fe₁₄B, Neomax®) cannot tolerate. Pure Samarium-Cobalt (SmCo) magnets (both SmCo₅ and Sm₂Co₁₇) satisfy this requirement and are less subject to corrosion than the neodymium-based magnets and thus do not require a coating. Moreover, pure SmCo magnets have strong resistance to demagnetization.

Three basic material parameters determine the intrinsic properties of hard magnetic materials: (i) spontaneous (saturation) magnetization, (Mₛ), (ii) Curie temperature (T_{c}), and (iii) magnetocrystalline anisotropy energy (MAE). An optimal technological permanent magnet has a large spontaneous magnetization (Mₛ≥˜1 MA), high Curie temperature (T_{c}≥˜550 K), and large MAE constant (K₁≥˜4 MJ/m³).

Pure YCo₅ permanent magnets exhibit high uniaxial MAE constant of K₁˜6.5 MJ/m³, which is excessive compared to that of Nd₂Fe₁₄B magnets having MAE with a K₁ of ˜4.9 MJ/m³. YCo₅ permanent magnets have high Curie temperature, T_{c}˜987 K, which is almost twice that of Nd₂Fe₁₄B magnets having Curie temperature, T_{c}˜588 K. However, the Nd₂Fe₁₄B magnet currently dominates the world market for permanent magnets (˜62% of world market), since the Nd₂Fe₁₄B magnet has large spontaneous magnetization and possesses the highest energy performance measured by a record high energy product. The Maximum Energy Product (BH)ₘₐₓ of the Nd₂Fe₁₄B magnet at 512 kJ/m³ is more than twice as high as the (BH)ₘₐₓ of YCo₅ magnets, at 224 kJ/m³.

It would be desirable to formulate a permanent magnet with a greater spontaneous magnetization, high MAE and thermostability comparable to YCo₅ magnets while having a high Curie temperature.

### SUMMARY

In accordance with one aspect of the presently disclosed inventive concepts, a magnet includes a material having a chemical formula: YFe₃(Ni₁₋ₓCoₓ)₂, where x is greater than 0 and x is less than 1.

In accordance with another aspect of the presently disclosed inventive concepts, a magnet includes a material having a chemical formula: YFe₃(Ni₁₋ₓCoₓ)₂, where x is greater than 0 and x is less than 1, and where the material has a CuCa₅-type crystal structure.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of a crystal structure (CaCu₅-type) of a YCo₅ compound, according to inventive concepts described.

FIG. 2A depicts the heat of formation of the pseudo-binary YFe₃(Ni₁₋ₓCoₓ)₂ alloys predicted via ab initio (0K) and CALculation of PHAse Diagrams (CALPHAD) (298 K) calculations, according to inventive concepts described.

FIG. 2B depicts the heat of formation of the pseudo-binary SmFe₃(Ni₁₋ₓCoₓ)₂ alloys predicted via ab initio calculations, according to inventive concepts described.

FIG. 3 depicts a Y—Co phase diagram calculated using the CALPHAD assessment where RE=Y and TM=Co, according to inventive concepts described.

FIG. 4 depicts the Curie temperature of the pseudo-binary YFe₃(Ni₁₋ₓCoₓ)₂ alloys, according to inventive concepts described.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The term “dopant” as used in the instant descriptions shall be understood to encompass any element or compound that is included in a host medium material, so as to convey a particular functional characteristic or property on the resulting structure. In most cases, the dopant will be incorporated into a crystal structure of the host medium material.

In accordance with one general aspect of the presently disclosed inventive concepts, a magnet includes a material having a chemical formula: YFe₃(Ni₁₋ₓCoₓ)₂, where x is greater than 0 and x is less than 1.

In accordance with another general aspect of the presently disclosed inventive concepts, a magnet includes a material having a chemical formula: YFe₃(Ni₁₋ₓCoₓ)₂, where x is greater than 0 and x is less than 1, and where the material has a CuCa₅-type crystal structure.

A list of acronyms used in the description is provided below.

Å angstrom

at % atomic percent

(BH)ₘₐₓ Maximum Energy Product

Co Cobalt

DFT Density functional theory

LDA Local density approximation

GGA General gradient approximation

EF Fermi level

Fe Iron

GPa gigapascal

K Kelvin, T_{c} temperature

K₁ Magnetocrystalline anisotropy energy constant

kJ kilojoules

m meters

MA mega amperes

meV milli-electronvolts

MJ megajoules

MAE Magnetocrystalline anisotropy energy

DLM Disordered local moment

AF Antiparallel fashion

FREMTO Fully relativistic exact muffin-tin orbital

CPA Coherent potential approximation

FPLMTO Full-potential linear muffin-tin orbital method

m^{(tot)} total moment

m^{(s)} spin magnetic moment

m^{(o)} orbital magnetic moment

Mₛ spontaneous magnetization

Nd Neodymium

Ni Nickel

Ca Calcium

Cu Copper

RE Rare earth metal

Sm Samarium

Y Yttrium

T_{c} Curie temperature

TM Transition-Metal

μ_{B} Bohr magneton

According to various inventive concepts described herein, a permanent magnet may be formed that has a high spontaneous magnetization, thermostability, high Curie temperatures and high magnetocrystalline anisotropy energy (MAE). Ideally, transition-metal dopants may boost the energy product of YCo₅ magnets without compromising the high MAE and high Curie temperatures of these magnets. For example, combining transition-metal (TM) with rare-earth-metal (RE) atoms in various intermetallic compounds may result in material in which RE and TM atoms induce a large magnetic anisotropy and provide a large magnetization and high Curie temperature.

Iron (Fe) is more readily available than cobalt (Co) such that Fe is ˜2000 times more abundant in the Earth's crust than Co. Thus, at least from a cost standpoint, it would be beneficial to substitute Co atoms in YCo₅ with Fe atoms since the relative abundance of available Fe could result in a less expensive component. In addition, Fe may be desirable as an added component to a magnet material since its ferromagnetic metal properties have a large magnetization at room temperature (1.76 MA/m).

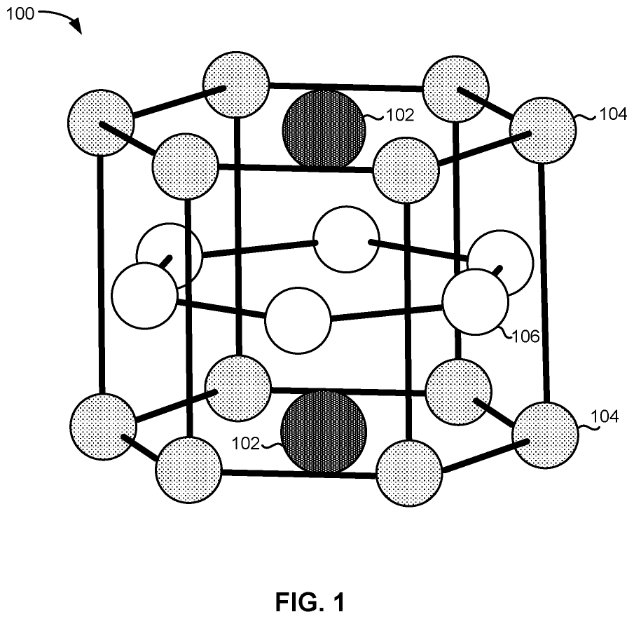

FIG. 1 depicts a structure 100 of a material of a magnet, in accordance with inventive concepts described herein. As an option, the present structure 100 may be implemented in conjunction with features from any other inventive concepts listed herein, such as those described with reference to the other FIGS. Of course, however, such structure 100 and others presented herein may be used in various applications and/or in permutations which may or may not be specifically described in the illustrative concepts listed herein. Further, the structure 100 presented herein may be used in any desired environment.

As shown in FIG. 1, the crystal structure of a CaCu₅(D_{2d})-type Structure 100 with three distinct atoms displayed, may represent a YCo₅ compound crystal structure in accordance with some approaches. An yttrium atom (Y₁) may be in the Wyckoff position 1a 102 centered in a plane with two Co₁ atoms in the position 2c 104 surrounding the Y₁ in the position 1a 102 and a second layer with three more Co₂ atoms in the position 3g 106 for a total of six atoms in the unit cell. Bonding and energy between the atoms of a crystal structure may be defined by the interactions between 3d-orbital electrons of the transition metals in the position 2c 104 or position 3g 106 and the 5d-orbital electrons from yttrium (Y₁) in the center position 1a 102 as shown in FIG. 1.

In the YFe₅ compound that only includes Fe atoms without any Co atoms, the instability of the crystal structure may be related to a decrease in the number of 3d electrons in the electronic structure. Indeed, crystal stabilities of the magnetic 3d transition metals may be governed by the number of 3d electrons.

Thus, substituting all cobalt atoms with a transition metal with higher magnetic moment, such as iron, in order to optimize the maximum energy product (i.e., YCo₅→YFe₅) may result in a thermodynamically unstable crystal structure of an ordinary hexagonal phase. Moreover, YFe₅ does not appear in the equilibrium Y—Fe phase diagram, although the alloy compound Y(Co₁₋ₓFeₓ)₅ with CaCu₅-type structure has been synthesized for x=0.2 to 0.4.

For synthesized Y(Co₁₋ₓFeₓ)₅ materials, the Curie temperatures (T_{c}) for Y(Co₁₋ₓFeₓ)₅ alloys were found to increase from about 930 K to about 1020 K when increasing x from 0.0 to 0.2. In contrast, Y₂(Co₁₋ₓFeₓ)₁₇ alloys exhibit a monotonic decrease in Curie temperature (T_{c}) with increasing Fe content. The orbital moment of cobalt is larger compared to iron, and a decrease of the MAE occurs for x>0. The lattice constant and magnetization are enhanced for x=0 to 0.4 in Y(Co₁₋ₓFeₓ)₅ alloys.

Accordingly, the inventive concepts presented herein, in several embodiments, involve ab initio calculations to add nickel (Ni) and iron (Fe) to a YCo₅ magnet in order to stabilize Y(Co—Fe—Ni)₅ alloys containing a sufficient amount of Fe to boost the energy product of the Y(Co—Fe—Ni)₅ magnet.

In accordance with inventive concepts described herein, a magnet includes a material having a chemical formula: YFe₃(Ni₁₋ₓCoₓ)₂, wherein x may be greater than 0 and x may be less than 1. In some approaches, the material may have a chemical formula: YFe₃(Ni₁₋ₓCoₓ)₂, where x may be greater than 1−x such that the compound has a greater amount of Co compared to Ni. Accordingly, x may be a value between 0.5 and 1, such as 0.51, 0.52 . . . 0.98, 0.99. In other approaches, the material may have a chemical formula: YFe₃(Ni₁₋ₓCoₓ)₂, where x may be less than 1−x, such that the compound has a greater amount of Ni compared to Co. Accordingly, x may be a value between 0 and 0.5, such as 0.01, 0.02 . . . 0.48, 0.49. Preferably, whether x is greater than or less than 1−x, the values are within a 10% difference of one another, e.g., x is a value in a range of 0.45-0.55. In preferred approaches, the material may have a chemical formula: YFe₃(Ni₁₋ₓCoₓ)₂, where x is about equal to 1−x.

In at least one contemplated approach, in addition to iron and nickel, copper may be used to dope the YCo₅ magnets as described herein. In contrast to the Y(Co₁₋ₓFeₓ)₅ system, Y(Co₁₋ₓNiₓ)₅ and Y(Co₁₋ₓCuₓ)₅ compounds are stable across the composition domain comprising x=0 to 1. Substituting cobalt atoms with nickel and/or copper atoms gradually decreases magnetization and magnetic anisotropy.

Preferably, the magnet as described in the inventive concepts herein includes a lower (e.g., reduced) amount of cobalt (up to 75% less Co) than the amount of Co in YCo₅. Moreover, the magnet as described may be a permanent magnet.

The magnet compound of YFe₃(Ni₁₋ₓCoₓ)₂ material as described herein may have a CaCu₅-type crystal structure. Referring again to FIG. 1, the YFe₃(Ni₁₋ₓCoₓ)₂ may form a hexagonal CaCu₅-type structure 100: Y₁ in position 1a 102, Co atoms, Fe atoms, and Ni atoms sharing transition metal position 2c 104 sites and position 3g 106 non-equivalent atomic sites with 6 atoms per formula unit. In at least one exemplary aspect, Fe atoms occupy all 3g 106 positions of the CaCu₅-type structure and the YFe₃(Ni₁₋ₓCoₓ)₂ alloy remains thermodynamically stable until approximately all Ni atoms (which occupy all the 2c 104 positions) are substituted by Co atoms.

In the inventive concepts described herein, a thermodynamically stable permanent magnet, for example having the chemical formula YFe₃(Ni_{0.5}Co_{0.5})₂, may include no more than three Fe atoms per unit of the compound. Ideally, the Fe atoms would be distributed in the transition metal position 3g 106 nonequivalent atomic sites (as shown in FIG. 1) of the crystal structure 100.

According to inventive concepts described herein, the addition of Ni to Y(Co₁₋ₓFeₓ)₅ magnets may stabilize the magnet. Transition metals have increasing 3d electron count in the following order: Fe<Co<Ni. Thus, replacing Co atoms with Fe atoms decreases the amount of 3d electrons in the compound, whereas replacing Co atoms with Ni atoms increases the amount of 3d electrons in the compound.

According to inventive concepts described herein, the resulting YFe₃(Ni₁₋ₓCoₓ)₂ magnet may have a large energy product. State of the art electronic structure calculations confirmed that addition of Ni to YCo₅ magnets stabilized Y(Co₁₋ₓFeₓ)₅ and maintained a reasonably high MAE comparable with the MAE of YCo₅ magnets (see below in Experiments and Modeling Results).

According to inventive concepts described herein, a magnet with YFe₃(Ni₁₋ₓCoₓ)₂ material includes Fe atoms, Ni atoms and the Co atoms which may be distributed in transition metal 2c 104 nonequivalent atomic sites. Moreover, high axial MAE may be obtained with energetically stable YFe₃(Ni₁₋ₓCoₓ)₂ alloys using abundant and cost-effective Fe and Ni in place of expensive Co, and thereby achieving higher magnetic energy product compared to the YCo₅ prototype compound. Some approaches may include a YFe₃(Ni₁₋ₓCoₓ)₂ compound with partial ordering on the 2c-type 104 sites.

A magnet of YFe₃(Ni₁₋ₓCoₓ)₂ includes a spin orientation of the Y atom that may be antiparallel to a spin orientation of the Fe, Ni, and Co atoms. The spin properties of the electrons in an atom generate a magnetic moment of the atom, as measured in terms of Bohr magneton (μ_{B}). Theoretical measurements of the YFe₃(Ni₁₋ₓCoₓ)₂ magnet show magnetic moments of Y to be opposite atoms of each of the transition metals (e.g., Co, as shown below in Table 1).

Permanent magnets preferably include material with a high magnetocrystalline anisotropy energy (MAE). The MAE is the very small energy difference between phases with spin moments oriented in the easy and hard directions. The MAE may be defined by appropriate representation of the electronic and magnetic structures. In terms of uniaxial anisotropy, the MAE constant K₁>0, where the MAE constant K₁ is expressed in MJ/m³ units. The opposite case, K₁<0, corresponds to the planar anisotropy. The magnitude of the MAE constant, K₁, reflects the magnitude of MAE such that a larger positive value of K₁ constant corresponds to a larger uniaxial MAE.

A magnet of YFe₃(Ni₁₋ₓCoₓ)₂ may have a MAE that is about twice a MAE of Nd₂Fe₁₄B. In some approaches, a magnet of YFe₃(Ni₁₋ₓCoₓ)₂ has a magnetocrystalline anisotropy energy constant (K₁) that may be greater than about 10.6 MJ/m³.

In some approaches, the YFe₃(Ni₁₋ₓCoₓ)₂ material may have a high MAE that may be comparable to the MAE of praseodymium (PrCo₅), samarium (SmCo₅), yttrium (YCo₅) magnets of 8.1 MJ/m³, 17.2 MJ/m³ and 6.5 MJ/m³, respectively. The theoretical values of the YFe₃(Ni₁₋ₓCoₓ)₂ compounds described herein were derived using novel computational material science approaches (see below in Experiments and Modeling Results).

It is desirable for a magnet material to have a high Curie temperature (T_{c}) in order to continue to function as a magnet under conditions with elevated temperatures. According to inventive concepts described herein, the material of the magnet YFe₃(Ni₁₋ₓCoₓ)₂ has a Curie temperature (T_{c}) that may be about equal to a Curie Temperature of YCo₅. In some approaches, the material of the magnet YFe₃(Ni₁₋ₓCoₓ)₂ may have a T_{c} greater than or equal to about 1000 K.

Moreover, the YFe₃(Ni₁₋ₓCoₓ)₂ compound may have a high magnetic energy product, comparable to neodymium-based magnets. The material of the magnet YFe₃(Ni₁₋ₓCoₓ)₂ may have a maximum energy product of the material greater than or equal to about 351 kJ/m³. In one exemplary aspect, a YFe₃CoNi magnet may have a maximum energy product of the material greater than about 309 kJ/m³. In various aspects, a YFe₃CoNi magnet may have a maximum energy product of the material greater than or equal to about 300 kJ/m³.

In at least one exemplary aspect, a thermodynamically stable YFe₃(Ni_{0.3}Co_{0.7})₂ magnet may be created by substituting up to an additional 30 at. % Ni for Co having a T_{c} of 900 K which is close to the calculated T_{c} of YCo₅ magnet's T_{c} of 892 K. The YFe₃(Ni_{0.3}Co_{0.7})₂ magnet may have a maximum energy product of the material greater than about 351 kJ/m³.

In another exemplary aspect, a YFe₃Co₂ magnet may be created having a Curie temperature T_{c} of 1098 K and a maximum energy product of 365 kJ/m³, according to various aspects described herein. The foregoing maximum energy product is about 71% of the maximum energy product for Nd₂Fe₁₄B magnets (e.g., 512 kJ/m³).

There are potentially many ways to produce the magnets described here, as would be readily apparent to one skilled in the art after reading the present disclosure. Any such method may be used to present the novel materials described herein.

An illustrative method to form a permanent magnet, which is presented by way of example only, may include starting with a YNi₅ compound that is in a CaCu₅-type structure. A maximum amount of Fe metal (e.g., ˜60 at %) may be dissolved with the YNi₅ compound to form a stable YFe₃Ni₂ compound in the same structure modification where iron atoms predominantly occupy 3g sites of the crystal structure. In an ideal crystal structure, Fe atoms occupy all 3g positions.

The formation method may subsequently include gradual alloying of the YFe₃Ni₂ compound with Co, while keeping the amount of Y and Fe constant. In a preferred embodiment, up to 92% of the Ni atoms may be replaced with Co atoms.

Experiments and Modeling Results

YCo₅ compounds crystallize in the hexagonal CaCu₅-type structure with three non-equivalent atomic sites: Y₁-(1a) 102, Co₁-(2c) 104, and Co₂(3g) 106 (see FIG. 1) with six atoms per formula unit and per computational cell.

Earlier neutron-diffraction studies of the Th(Co₁₋ₓFeₓ)₅ alloys (also based on the CaCu₅-type structure) show that the larger Fe atoms preoccupies the 3g-type 106 sites, whereas the smaller Co atoms choose to occupy the 2c-type 104 sites. This occupational inclination has been affirmed by DFT calculations for YCo₅ and SmCo₅ compounds. In line with these calculations, the total energy for Fe at the 3g 106 site (E_{3g}) is lower that than for Fe at the 2c 104 site (E_{2c}) by 0.21 eV/f.u. and 0.10 eV/f.u. for YCo₅ and SmCo₅ magnets, correspondingly. If the YCo₅ magnet is doped with Fe and Ni, Fe atoms occupy preferentially 3g 106 sites, while Ni atoms favor 2c 104 sites.

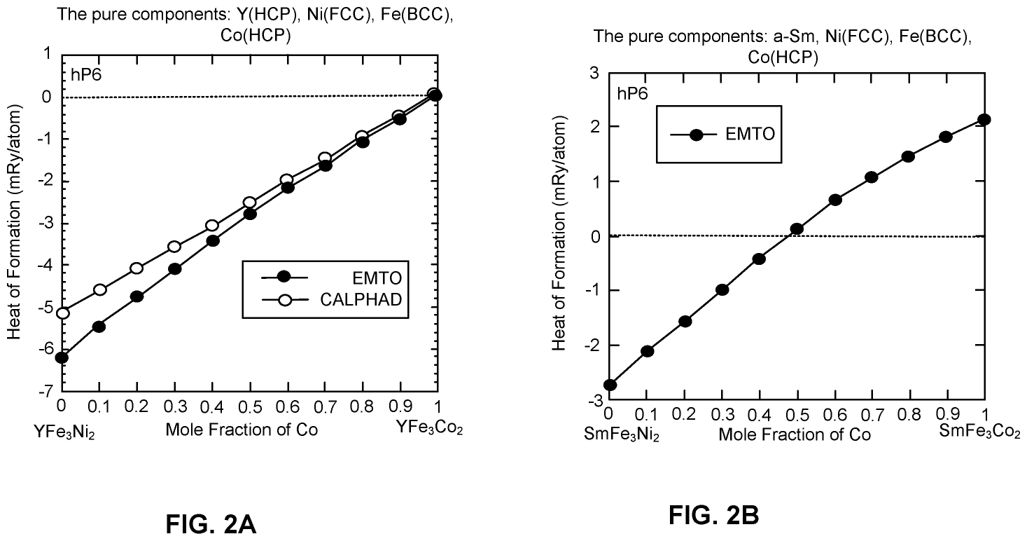

FIG. 2A depicts the heat of formation calculated within the EMTO-CPA technique of the pseudo-binary YFe₃(Ni₁₋ₓCoₓ)₂ alloys where Fe atoms occupy all 3g-type 106 sites, and the occupation of the 2c-type 104 sites continuously changes from pure Ni (the YFe₃Ni₂ compound) to pure Co (the YFe₃Co₂ compound). The current calculations show that the YFe₃(Ni₁₋ₓCoₓ)₂ alloys remain stable until almost all Ni atoms are replaced by Co atoms.

FIG. 2B depicts the heat of formation calculated within the EMTO-CPA formalism of the pseudo-binary SmFe₃(Ni₁₋ₓCoₓ)₂ alloys where Fe atoms occupy all 3g-type 106 sites, and the occupation of the 2c-type 104 sites continuously changes from pure Ni (the SmFe₃Ni₂ compound) to pure Co (the SmFe₃Co₂ compound). These calculations show that the pseudo-binary SmFe₃(Ni₁₋ₓCoₓ)₂ alloys could remain stable until almost half of Ni atoms are replaced by Co atoms.

Nickel metal forms the stable CaCu₅-type compounds with both yttrium and samarium metals. Calculated within EMTO formalism, the heat of formation of SmNi₅ and YNi₅ compounds (in the CaCu₅-type structure) is −18.95 mRy/atom and −22.91 mRy/atom, correspondingly, which is in accord with the experimental measurements of −23.08 mRy/atom (−30.3 kJ/mole, SmNi₅) and −25.98 mRy/atom (−34.1 kJ/mole, YNi₅). The YFe₅ compound as well as the SmFe₅ compound do not exist in the equilibrium Y—Fe and Sm—Fe phase diagrams, correspondingly, thus no experimental information about the heat of formation of these hypothetical compounds is available. However, the EMTO calculations show that the heat of formation of the YFe₅ compound is positive, +6.46 mRy/atom, and is half of the calculated heat of formation of the SmFe₅ compound, +12.68 mRy/atom. As a result, the calculated heat of formation of the YFe₃Co₂ compound, +0.09 mRy/atom, appears to be smaller than the calculated heat of formation of the SmFe₃Co₂ compound, +2.15 mRy/atom. The computed heats of formation of the YFe₃Ni₂ and the SmFe₃Ni₂ compounds are both negative (stable compounds), however, the absolute value of the calculated heat of formation of the YFe₃Ni₂ compound, |−6.20| mRy/atom, is more than twice as high as the absolute value of the heat of formation of the SmFe₃Ni₂ compound, |−2.72| mRy/atom. As a result, the region of stability of the pseudo-binary YFe₃(Ni₁₋ₓCoₓ)₂ alloys appears to be almost twice as wide as the region of stability of the pseudo-binary SmFe₃(Ni₁₋ₓCoₓ)₂ alloys.

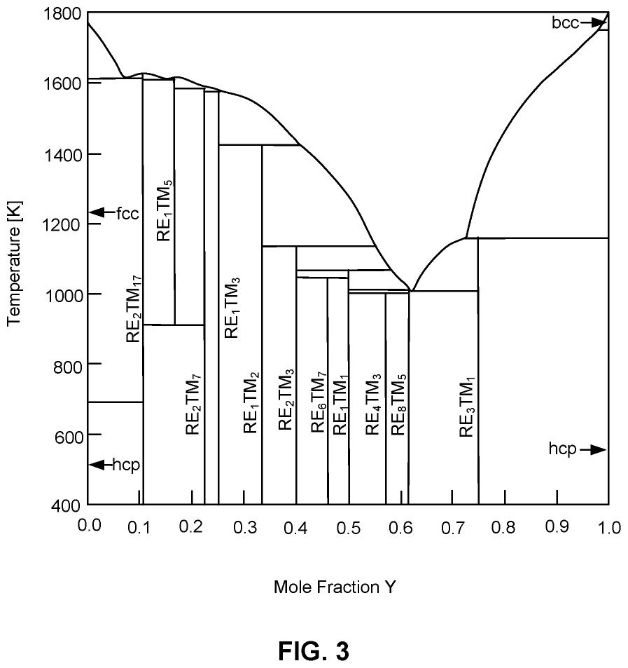

FIG. 3 depicts a Y—Co phase diagram exhibiting agreement with experiments: (i) congruent melting of Y₂Co₁₇ and YCo₅ at 1630 K (exp.: 1630 K) and 1615 K (exp.: 1623 K), correspondingly; (ii) decomposition temperature of YCo₅ at 914 K (exp.: ˜998 K); (iii) heat of formation of YCo₅ equal to ‘−12.46 kJ/mole and ‘−13.61 kJ/mole at 298 and 1000 K, correspondingly, compared with ‘−12.20±0.87 kJ/mole measured between 850 and 1200 K; (iv) heat of formation of Y₂Co₁₇ equal to ‘−8.74 kJ/mole and ‘−9.47 kJ/mole at 298 and 1000 K, correspondingly, compared with ‘−7.6±0.80 kJ/mole measured between 850 and 1200 K.

TABLE 1
Site-projected spin, m^{(s)}, and orbital m^{(o)},
magnetic moments for the YCo₅ compound
FREMTO calculations. m^{(tot)} = 7.82 μ_{B}/f.u.

| Component | Y₁(1a) | Co₁(2c) | Co₂(3g) |
|---|---|---|---|
| m^{(s)} (μ_{B}) | +0.31 | −1.55 | −1.47 |
| m^{(o)} (μ_{B}) | −0.01 | −0.14 | −0.11 |

Y and Co spins align in an antiparallel fashion (AF) that is predicted in the present self-consistent calculations. The calculated total moment, m^{(tot)}=7.82μ_{B}/f.u., is slightly smaller than the experimentally reported value of 8.30μ_{B}/f.u. The calculated spin moments are 1.55μ_{B} and 1.47μ_{B} for 2c 104 and 3g 106 sites, correspondingly, which are larger than the recorded experimental values of 1.44μ_{B} and 1.31μ_{B}. The calculated orbital moments are 0.14μ_{B} and 0.11μ_{B} for 2c 104 and 3g 106 sites, correspondingly, which are smaller than recorded experimental data of 0.26μ_{B} and 0.24μ_{B}. The present FREMTO calculations reflect the experimental (spin flip-neuron scattering) observation; for the YCo₅ compound, the orbital moment of Co₁(2c) 104 atoms is bigger than the orbital moment of Co₂(3g) 106 atoms. The large MAE of the YCo₅ compound comes from a big orbital allowance from Co₁(2c) 104 sites, which are located in the same plane as Y₁(1a) 102 sites. Appropriately, Co₁(2c) 104 atoms have a big positive MAE allowance, while Co₂(3g) 106 atoms have a small negative MAE allowance. The axial (positive) MAE of the YCo₅ magnet can be achieved only if orbital moments on the Co₁(2c) 104 atoms are bigger than the orbital moments of the Co₂(3g) 106 atoms.

A mean-field treatment for the Curie temperature, T_{c}, can be formulated as:

$${T}_{c} = \frac{2}{3} \times \frac{{E}_{tot}^{DLM} - {E}_{tot}^{AF}}{{k}_{B}}$$

where

$$( \frac{{E}_{tot}^{DLM} - {E}_{tot}^{AF}}{{k}_{B}} )$$

is the difference among the ground state total energies of the DLM and the AF state, and k_{B} is the Boltzmann constant. Principally, an assessment of the Curie temperature can be achieved from the total energy difference between the ferromagnetic (or antiferromagnetic) and the paramagnetic states. The difference between the total energies can be substituted by the difference between the effective single-particle (one atomic specie) energies, which are directly associated with AF and DLM states (the so-called mean-field treatment). In the present work, Eₜₒₜ^{DLM} and Eₜₒₜ^{AF} are calculated at the equilibrium volumes for DLM and AF states, correspondingly. According to the present EMTO-DLM and EMTO-AF calculations, T_{c}=891.8 K for the YCo₅ magnet, which is in good accord with the experimental data T_{c}=920 K, which is relatively larger than that of the commonly used Nd₂Fe₁₄B magnet (T_{c}=588 K). Similar EMTO calculations reveal T_{c}=1149.3 K for the YFe₅ compound, although this compound does not exist in the Y—Fe phase diagram. There is an experimentally observed tendency of the Curie temperature to increase with Fe doping of the YCo₅ magnet, i.e., from T_{c}=930 K (the YCo₅ compound) to T_{c}=1020 K (the Y(Co_{0.8}Fe_{0.2})₅ compound).

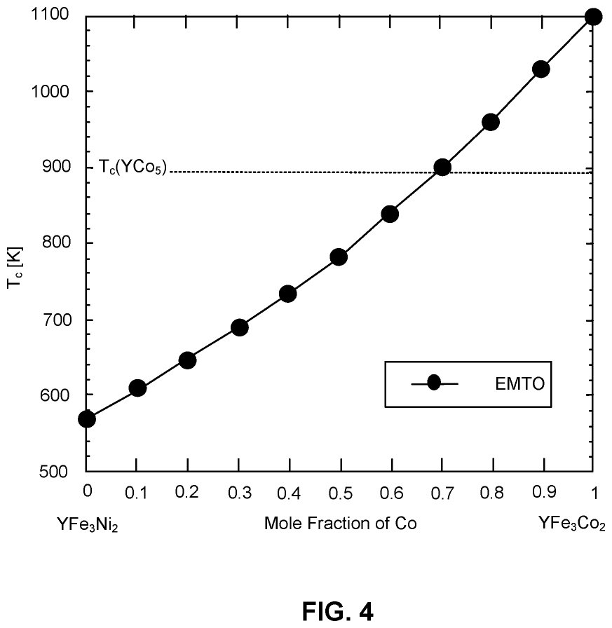

FIG. 4 depicts the Curie temperature calculated within the EMTO-CPA technique of the pseudo-binary YFe₃(Ni₁₋ₓCoₓ)₂ alloys where Fe atoms occupy all 3g-type 106 sites, and the occupation of the 2c-type 104 sites continuously changes from pure Ni (the YFe₃Ni₂ compound) to pure Co (the YFe₃Co₂ compound). The dotted line corresponds to the calculated Curie temperature of the YCo₅ magnet, T_{c}=891.8 K. The calculated Curie temperature is equal to 572.6 K and 1097.7 K for the YFe₃Ni₂ and YFe₃Co₂ magnets, correspondingly. Although the calculated Curie temperature of the YFe₃Ni₂ compound lies about 320 K below of the Curie temperature of the YCo₅ magnet, this deficiency can be removed by substituting 70 at. % of Ni by Co. The Curie temperature of the YFe₃(Ni_{0.3}Co_{0.7})₂ magnet is equal to 899.9 K.

According to the present calculations, the YFe₃(Ni_{0.3}Co_{0.7})₂ magnet shows an enormous total moment of m^{(tot)}˜9.79μ_{B}, essentially due to the iron atoms that each contribute with 2.45μ_{B}. The total moment of the YFe₃(Ni_{0.3}Co_{0.7})₂ magnet is thus essentially bigger than that of the traditional YCo₅ magnet that has a calculated total moment of m^{(tot)}˜7.82μ_{B}. The experimental values of saturation magnetization (Mₛ) and the maximum energy product ((BH)ₘₐₓ) for the YCo₅ magnet are 0.85 MA/m and 224 kJ/m³, correspondingly. Because saturation magnetization and magnetic moment are approximately proportional, Mₛ˜ m^{(tot)}, and the maximum energy product is approximately proportional to the square of the saturation magnetization, (BH)ₘₐₓ˜(Mₛ)², one can evaluate that saturation magnetization for the YFe₃(Ni_{0.3}Co_{0.7})₂ magnet is proportional to 1.064 MA/m and the maximum energy product for the YFe₃(Ni_{0.3}Co_{0.7})₂ magnet should be approximately 351 kJ/m³, which is ˜69% of the record maximum energy product of the Nd₂Fe₁₄B magnet, (BH)ₘₐₓ=512 kJ/m³. Particularly, the YFe₃(Ni_{0.3}Co_{0.7})₂ magnet, which has a Curie temperature similar to the YCo₅ magnet, is a substantially steadier magnet than the YCo₅ magnet (its maximum energy product should be ˜57% larger).

The magnetic anisotropy energy (MAE) is one of the more important properties of an efficient magnet. In the quest to increase the saturation magnetic moment or energy product, by substituting cobalt for iron, the impact of the doping on the MAE is reviewed.

TABLE 2
Calculated MAEs for the YCo₅-type magnets
alloyed with iron, nickel, or both.

| | Unit Cell Vol. | | | | K₁ | | | |
|---|---|---|---|---|---|---|---|---|
| | (Å³) | | c/a Ratio | | (meV/cell) | | K₁ (MJ/m³) | |
| Material | GGA | LDA | GGA | LDA | GGA | LDA | GGA | LDA |
| YFe₅ | 84.84 | 77.46 | 0.79 | 0.79 | 0.51 | 1.17 | 0.96 | 2.42 |
| YCo₅ | 82.65 | 76.38 | 0.80 | 0.80 | 9.89 | 6.44 | 19.17 | 13.51 |
| YNi₅ | 81.96 | 74.94 | 0.81 | 0.81 | 1.40 | 0.48 | 2.74 | 1.03 |
| YeFe₃Co₂ | 86.40 | 77.28 | 0.79 | 0.79 | 2.01 | 6.71 | 3.73 | 13.91 |
| YeFe₃CoNi | 86.22 | 76.38 | 0.81 | 0.82 | 4.51 | 5.04 | 8.38 | 10.57 |
| YeFe₃Ni₂ | 86.34 | 76.64 | 0.84 | 0.83 | 1.93 | 3.69 | 3.58 | 7.69 |

For the YFe₃Co₂ and the YFe₃CoNi magnets, the iron atoms are kept on the energetically favorably 3g 106 sites. In the case of YFe₃CoNi, Co and Ni are modeled as on the 2c 104 sites as two average atoms consistent with modeling of SmFe₃CoNi. In all calculations, the atomic volume is relaxed and the c/a axial ratio of the hexagonal phase. Some sensitivity is found (not shown) of the MAE to the axial ratios, suggesting that the structural relaxation is important.

According to the values calculated in Table 2, both YFe₅ and YNi₅ have relatively small magnetic anisotropy and, for that reason alone, they are not particularly strong magnets. YFe₅ is included in the table to provide context to the other magnets, as it does not exist in the hexagonal phase. YCo₅ contrarily exists and is predicted to have significant magnetic anisotropy. DFT-GGA calculations are relied on for these magnetic compounds because GGA performs better for the magnetic 3d transition metals relative to the LDA or even more modern approximations. GGA reproduces the proper magnetic ground state of iron, as opposed to the LDA. The GGA calculations reproduce the experimental atomic volume very well but overestimate the MAE for YCo₅ relative to experimental data. DFT-GGA (T=0 K) gives the unit cell volume V_{cell}=82.65 Å³ and anisotropy K₁=9.89 meV/cell (19.2 MJ/m³). These numbers are compared to experimental data at T=4.1 K, V_{cell}=82.50 Å³, K₁=3.80 meV/cell (7.38 MJ/m³) and at T=293 K, V_{cell}=83.99 Å³, K₁=3.04 meV/cell (5.80 MJ/m³). Here, the unit cell volume at T=4.1 K, V_{cell}=82.50 Å³ is identified using the experimental value of the MAE coefficient, K₁, presented in the units of (MJ/m³), and (meV/cell).

Replacing most of Co with Fe in the YCo₅ magnet and using Ni as a thermodynamic mediator results in an YFe₃CoNi magnet with desired magnetic properties such as a very high Curie temperature, robust magnetic anisotropy, and a relatively large maximum energy product. YFe₃CoNi magnets use nickel metal as the stabilizing material in the YCo₅ magnet in order to accommodate the maximum amount of iron metal to favor a very high magnetization.

For YFe₃(Ni₁₋ₓCoₓ)₂ alloys, it is possible to have stable solutions until approximately all Ni atoms are substituted by Co atoms. The ab initio heat of formation predictions are confirmed by CALPHAD modeling at 298 K. The combination of negative heat of formation and extended solubility limits experimentally observed in the YTM₅ (TM=Co, Fe, Ni) magnets (e.g., complete solubility from YCo₅ to YNi₅ at 1073 K and 1273 K; solubility of ˜20 at. % Fe in Y(Co,Fe)₅ at 1323 K; solubility of ˜30 at. % Fe in Y(Fe,Ni)₅ at 873 K) is promising for synthesis of the foregoing magnets. A specific example includes a YFe₃Co₂ magnet for which the calculated the Curie temperature, T_{c}, which is equal to 1097.7 K and the maximum energy product, (BH)ₘₐₓ(YFe₃Co₂), as ˜365 kJ/m³, which is ˜71% of the record maximum energy product of the Nd₂Fe₁₄B magnet, (BH)ₘₐₓ=512 kJ/m³. Here, the maximum energy products of YFe₃Co₂ and YFe₃CoNi magnets are estimated using the calculated total magnetic moments of YFe₃Co₂, YFe₃CoNi, and YCo₅ magnets as well as the experimental values of the saturated magnetization and the maximum energy product of the YCo₅ magnet. Calculations are performed in the same fashion as for the YFe₃(Ni_{0.3}Co_{0.7})₂ magnet.

According to the presently disclosed calculations, the YFe₃(Ni_{0.3}Co_{0.7})₂ magnet has a Curie temperature T_{c}˜900 K that is relatively close to the calculated Curie temperature of the YCo₅ magnet, T_{c}˜ 892 K. In addition, the maximum energy product of the YFe₃(Ni_{0.3}Co_{0.7})₂ magnet is significantly improved compared to the YCo₅ magnet (˜57% larger). The calculated intrinsic properties of the magnets are reported in Table 3 in conjunction with the experimental data of Nd₂Fe₁₄B, SmCo₅, and YCo₅ magnets for comparison. All four suggested permanent magnets have a Curie temperature significantly higher than that of Nd₂Fe₁₄B, T_{c}˜ 588 K, spanning from 785 K to 1103 K. In addition, their maximum energy products are significantly higher than that of the commercially used SmCo₅ and YCo₅ magnets (231 kJ/m³ and 224 kJ/m³, respectively), reaching a maximum value of 365 kJ/m³ for YFe₃Co₂. Our calculated (Table 3, LDA) MAEs for YFe₃CoNi magnet is not much smaller than that of YCo₅ magnet (10.6 MJ/m³ and 13.5 MJ/m³, respectively).

TABLE 3
Intrinsic magnetic properties of Nd₂Fe₁₄B, SmCo₅, and
YCo₅ permanent magnets (experiment) and
SmFe₃CoNi, YFe₃CoNi, (K₁, LDA), YFe₃(Ni_{0.3}Co_{0.7})₂,
and YFe₃Co₂ permanent magnets (theory).

| | Mₛ, | T_{c} | K₁ | (BH)ₘₐₓ |
|---|---|---|---|---|
| Material | (MA/m) | (K) | (MJ/m³) | (kJ/m³) |
| Nd₂Fe₁₄B | 1.28 | 588 | 4.9 | 512 |
| SmCo₅ | 0.86 | 1020 | 17.2 | 231 |
| YCo₅ | 0.85 | 987 | 6.5 | 224 |
| SmFe₃CoNi | 1.08 | 1103 | 9.2 | 361 |
| YFe₃CoNi | 1.00 | 785 | 10.6 | 309 |
| YFe₃(Ni_{0.3}Co_{0.7})₂ | 1.06 | 900 | | 351 |
| YFe₃Co₂ | 1.14 | 1098 | | 365 |

In Use

Considering SmFe₃CoNi and YFe₃CoNi magnets comprise up to 80% less Co than their SmCo₅ and YCo₅ precursors, maturing of these magnets becomes even more captivating from the current economic viewpoint. Replacing part of cobalt with iron in SmCo₅ and YCo₅ magnets stabilized with a small portion of nickel results in permanent magnets having many desirable characteristics. These permanent magnets are anticipated to have outstanding magnetic properties, a large maximum energy product, a strong magnetic anisotropy, and an exceptionally high Curie temperature.

In use, the alloy formulations described herein may be useful as permanent magnets with high MAE and energy product, and useful for high-temperature applications (e.g., Curie temperatures in a range of about 900 K to about 1100 K). The YCoNiFe₃ and SmCoNiFe₃ alloy formulations described herein may be used for cost-effective clean energy products, turbines, electric car battery applications, etc.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A magnet, comprising:
a material having a chemical formula: YFe₃(Ni₁₋ₓCoₓ)₂, wherein x is greater than 0 and x is less than 1.

2. A magnet as recited in claim 1, wherein x is greater than 1−x.

3. A magnet as recited in claim 1, wherein x is less than 1−x.

4. A magnet as recited in claim 1, wherein x is about equal to 1−x.

5. A magnet as recited in claim 1, the material has a CuCa₅-type crystal structure.

6. A magnet as recited in claim 5, wherein the Fe atoms are distributed in a plurality of transition metal 3g nonequivalent atomic sites.

7. A magnet as recited in claim 5, wherein the Ni atoms and the Co atoms are distributed in a plurality of transition metal 2c nonequivalent atomic sites.

8. A magnet as recited in claim 1, wherein the magnet is a permanent magnet.

9. A magnet as recited in claim 1, wherein a spin orientation of the Y atom is antiparallel to a spin orientation of the Fe, Ni, and Co atoms.

10. A magnet as recited in claim 1, wherein a magnetocrystalline anisotropy energy of the material is about twice a magnetocrystalline anisotropy energy of Nd₂Fe₁₄B magnet.

11. A magnet as recited in claim 1, wherein a magnetocrystalline anisotropy energy of the material is greater than about 10 MJ/m³.

12. A magnet as recited in claim 1, wherein a Curie Temperature of the material is about equal to a Curie Temperature of YCo₅.

13. A magnet as recited in claim 1, wherein a Curie Temperature of the material is greater than about 1000 K.

14. A magnet as recited in claim 1, wherein a maximum energy product of the material is greater than about 351 kJ/m³.

15. A magnet as recited in claim 1, wherein the magnet comprises a reduced amount of Co than an amount of Co in YCo₅.

16. A magnet as recited in claim 15, wherein the reduced amount of Co is up to 75% less Co than the amount of Co in YCo₅.

17. A magnet, comprising:
a material having a chemical formula: YFe₃(Ni₁₋ₓCoₓ)₂, wherein x is greater than 0 and x is less than 1, wherein the material has a CuCa₅-type crystal structure.

18. A magnet as recited in claim 17, wherein x is greater than 1−x.

19. A magnet as recited in claim 17, wherein x is about equal to 1−x.

20. A magnet as recited in claim 17, wherein the Fe atoms are distributed in a plurality of transition metal 3g nonequivalent atomic sites.

21. A magnet as recited in claim 17, wherein the Ni atoms and the Co atoms are distributed in a plurality of transition metal 2c nonequivalent atomic sites.
